(19) United States
(12) Patent Application Publication
(10) Pub. No.: US 2002/0066340 A1
(43) Pub. Date: Jun. 6, 2002

(54) Magnetic driving tool having a telescopic pipe

(75) Inventor: Kuo Zhen Liu, Da Li City (TW)

Correspondence Address: HANDAL & MOROFSKY, 80 WASHINGTON STREET, NORWALK, CT, 06854, US

(73) Assignee: ICC Innovative Concepts Corp., Torrington, CT

(21) Appl. No.: 09/974,663

(22) Filed: Oct. 10, 2001

Related U.S. Application Data
(63) Continuation of application No. 09/259,725, filed on Mar. 1, 1999.
Application No. 09/259,725 is a continuation of application No. 08/957,968, filed on Oct. 21, 1997.
Application No. 08/957,968 is a continuation-in-part of application No. 08/643,026, filed on May 2, 1996, now abandoned.

(51) Int. Cl. B25B 23/08; B25B 23/10

(52) U.S. Cl. 81/451

(57) ABSTRACT

A screwdriver comprises a handle, a hollow outer sleeve, at least an inner pipe, and a bit. The rear end of the outer sleeve connects to the handle. The inner pipe is inserted in the interior of the outer sleeve via the front opening of the outer sleeve. A magnetic chuck is disposed at the front end of the inner pipe. The magnetic chuck is inserted in the rear portion of the bit.

### STATEMENT REGARDING FEDERALLY SPONSORED RESEARCH OR DEVELOPMENT

(Not applicable)

### BACKGROUND OF THE INVENTION

The invention relates to an extensible magnetic screwdriver. More particularly, the invention relates to an extensible screwdriver with a magnetic chuck.

The conventional screwdriver does not have any extensible rod. Thus the conventional screwdriver cannot reach a deep hole to screw or unscrew a bolt therein. If a bolt is unscrewed, the user cannot reach the deep hole to fetch the bolt. Further, the bit of any screwdriver may be fallen into the deep hole. The user cannot fetch the fallen bit with the conventional screwdriver.

### SUMMARY OF THE INVENTION

An object of the present invention is to provide an extensible screwdriver with a magnetic chuck in order t absorb a bit with the magnetic chuck.

Another abject of the present invention is to provide an extensible screwdriver with an extensible inner pipe in order to reach a deep hole.

Another object of the present invention is to provide an extensible screwdriver with plurality of extensible inner pipes in order to reach a deep hole.

Accordingly, an extensible screwdriver comprises a handle, a hollow outer sleeve, at least an extensible inner pipe, and a bit. The rear end of the outer sleeve connects to the handle. The inner pipe is inserted in the interior of the outer sleeve via the front opening of the outer sleeve. A magnetic chuck is disposed at the front end of the inner pipe. The magnetic chuck is inserted in the rear interior of the bit. When a bolt is fallen down in a deep hole of an article, the magnetic chuck of the inner pipe reaches the bolt and absorbs the bolt on the front end of the magnetic chuck. It is an option to provide two inner pipes in the interior of the outer sleeve in order to extend the magnetic chuck.

### BRIEF DESCRIPTION OF THE DRAWINGS

FIG. 1 is a perspective assembly view of a screwdriver of a preferred embodiment in accordance with the invention;

FIG. 2 is a perspective exploded view of FIG. 1;

FIG. 3 is a cross-sectional view of FIG. 1; and

FIG. 4 is a schematic view illustrating the operation of a screwdriver.

### DETAILED DESCRIPTION OF THE INVENTION

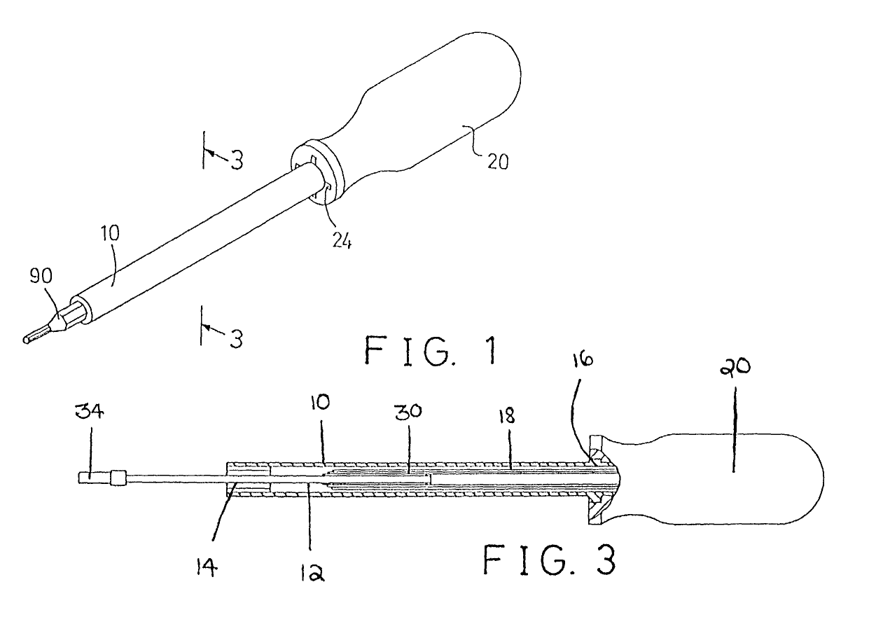

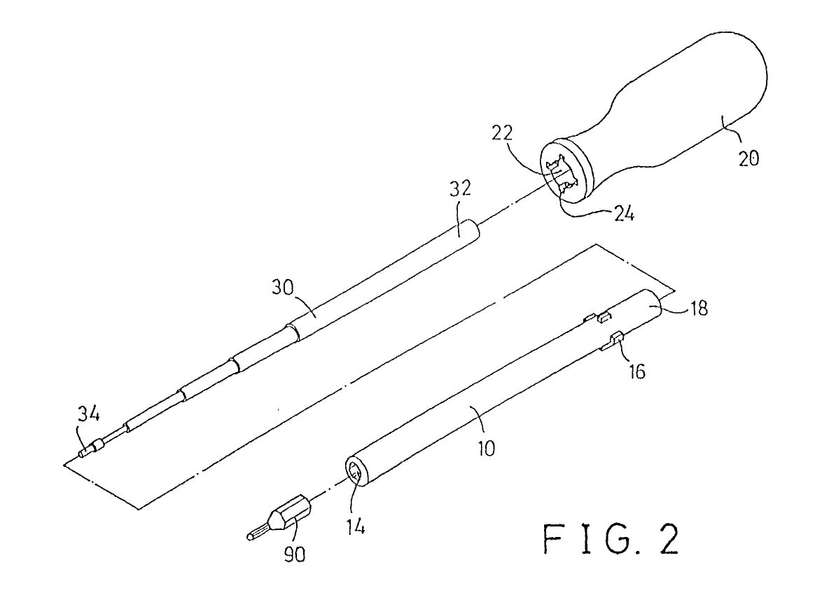

Referring to FIGS. 1 to 3, an extensible screwdriver comprises a handle 11, a hollow outer sleeve 10, at least an extensible inner pipe 14, and a bit 16. The rear end of the outer sleeve 10 connects to the handle 11. The inner pipe 14 is inserted in the interior 12 of the outer sleeve 10 via the front opening 13 of the outer sleeve 10. A magnetic chuck 15 is disposed at the front end of the inner pipe 14. The magnetic chuck 15 is inserted in the rear interior of the bit 16.

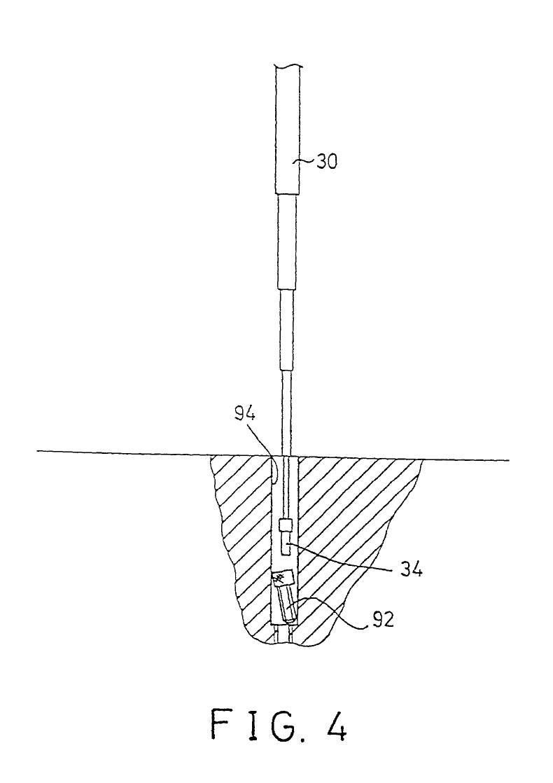

Referring to FIG. 4, a bolt 92 is fallen down in a deep hole 91 of an article 90. The magnetic chuck 15 of the inner pipe 14 reaches the bolt 92 and absorbs the bolt 92 on the front end of the magnetic chuck 15.

It is an option to provide two inner pipes in the interior of the outer sleeve in order to extend the magnetic chuck.

The invention is not limited to the above embodiments but various modification thereof may be made. Further, various changes in form and detail may be made without departing from the scope of the invention.

1. A screwdriver comprising:
a handle,
a hollow outer sleeve,
a rear end of said outer sleeve connecting to said handle,
at least an inner pipe inserted in an interior of said outer sleeve via a front opening of said outer sleeve,
a magnetic chuck disposed at a front end of said inner pipe,
said magnetic chuck inserted in a rear portion of a bit.
